(19) United States
(12) Patent Application Publication
(10) Pub. No.: US 2003/0055842 A1
(43) Pub. Date: Mar. 20, 2003

(54) System and method for automatically evaluating and provisionally granting educational transfer credits

(75) Inventors: Sharon Fields, St. Paul, MN (US); Kurt R. Linberg, Eden Prairie, MN (US)

Correspondence Address: Walter C Linder, Faegre & Benson LLP, 2000 Wells Fargo Center, 90 South Seventh Street, Minneapolis, MN, 55402-3901, US

(73) Assignee: Capella Education Company, Minneapolis, MN

(21) Appl. No.: 09/955,400

(22) Filed: Sep. 18, 2001

(51) Int. Cl. G06F 7/00

(52) U.S. Cl. 707/104.1

(57) ABSTRACT

A system and method for evaluating and granting educational transfer credits including a web server with an Internet interface, an automated registrar, and a database. The automated registrar is a software component which programmatically evaluates submitted transcript information for rendering an automatic credit transfer decision based on a successful hit ratio between keywords and a programmatically retrieved course description associated with a submitted course.

### CROSS-REFERENCE TO RELATED APPLICATION(S)

None.

### BACKGROUND OF THE INVENTION

This invention relates to a system for evaluating student transfer credits. More particularly, the present invention relates to a system and method for programmatically and automatically evaluating academic performance and course work content for the purpose of granting transfer credits at a second educational institution.

Transferring from one university or one college to another has always presented challenges. First, determining equivalency between two courses is sometimes difficult. Each university has its own naming conventions for naming classes, its own course numbering systems, and its own class requirements. “Introduction to Computing” at one school may require rudimentary programming in BASIC or PASCAL, while at another school, the same course title involves an historic overview of microprocessors and basic software programs. Transferring credits from one school to the other may not be seamless, and a review of the course description may be required in order to evaluate the transfer.

Additionally, the new school must ensure that if credits are accepted, the transferee has learned the material sufficiently that he or she will not be left behind in subsequent courses. Since many upper level courses assume working knowledge of core requirement courses and/or basic or entry level courses, some evaluation of performance may also be involved. A grade of B or better may be required for transfer of credits within a program. Additionally, grades or scores may be inflated or deflated according to the quality of students at the transferee's previous school. A student transferring credits taken at an Ivy League University may have a lower grade and yet have greater working knowledge of the subject matter than another student transferring credits from an unaccredited school. Transferring from a university to another university or from a college to another college typically involves manual analysis of the transcript and course catalog from the transferees previous college to determine whether course credits will be granted.

For many introductory level courses, such as “Introduction to Accounting,” many colleges will grant transfer credits based on the similarity of the course titles, in part, because the subject matter overlap between such introductory courses is typically close enough. However, courses within a field of study may have titles that are not common between different colleges. In such cases, a registrar typically must review the course catalog from the transferee's previous college and make a subjective determination based upon a review of the course descriptions. This subjective determination is time consuming and prone to error.

With the advent of new technologies such as high-end computers and with the growth of the Internet, distance education programs have become an increasingly popular alternative to traditional college settings. Within graduate programs, distance education is already being utilized by most major colleges to attract a broad cross section of individuals. Such distance learning programs typically attract busy professionals who are interested in advancing their careers by enhancing their education. Many such individuals simply do not have time to shop around from college to college to determine which college will give them the most transfer credits.

### BRIEF SUMMARY OF THE INVENTION

A system for programmatically and automatically evaluating previous coursework and granting educational transfer credits includes an Internet interface, a database, a program registrar agent, and administrative tools. The Internet interface provides a web-based form for a prospective transferee to enter transcript information anonymously. The transcript information is then submitted to the database and analyzed by the registrar agent to determine a conditional number of credits that can be granted for the previously taken course work. Using a customizable predefined successful hit ratio, the system evaluates the entered transcript information against core requirements within a selected course program, and renders a conditional transfer credit decision for the transferee. The decision is conditioned on verification of the transcript information provided by the potential applicant. The credit transfer decision is made programmatically by the registrar agent using either a single pass or multiple pass evaluation of both course title and course description from the previous college of the transferee, prior to completion of the transfer application process.

### BRIEF DESCRIPTION OF THE DRAWINGS

FIG. 1 is a schematic block diagram of the system of the present invention.

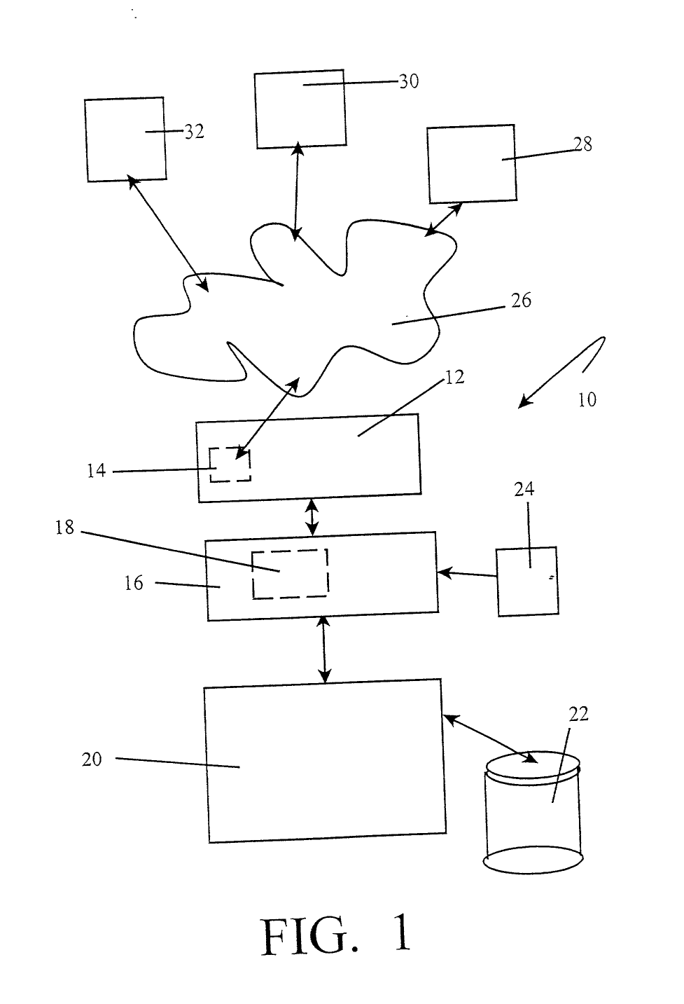

FIG. 2 is a schematic flow diagram of the credit transfer process of the present invention.

FIG. 3 is a schematic flow diagram of the operation of the registrar agent.

FIG. 4 is a schematic flow diagram of the set up procedure for the registrar agent.

FIG. 5 is a schematic flow diagram of a prospective transferee's interaction with the system of the present invention.

### DETAILED DESCRIPTION

The automated registration system 10 includes a web server 12 with a web site interface 14, an application server 16 containing an automated registrar 18, and a database server 20 in communication with a database 22. Each of the web server 12, the application server 16 and the database server 20 communicate via local area network (LAN) or wide area network (WAN). The servers 14,16,20 may be in close proximity to one another, or may be separated geographically. In the preferred embodiment, the web server 12, the application server 16 and the database server 20 reside on the same network.

An administrative tool 24 permits an authorized administrator to modify the automated registration process. The administrative tool 24 is a software program that can be stored on the application server 16 or on any computer in network communication with the application server 16. The administrative tool 24 provides access to credit transfer parameters used by the automated registrar 18 in rendering transfer credit decisions. Additionally, the administrative tool 24 allows an authorized user to modify the decision process.

Prospective students or transferees access the web interface 14 via the Internet 26 using computer workstations 28, web-enabled phones 30, personal digital assistants (PDAs) 32, or some other web-enabled device. The web interface 14 provides information regarding course offerings, curriculum requirements, tuition and financial aid information and the like, as well as forms for registering as a student, transferring credits, or logging on as an existing student.

Separating the application server 16 from the database server 20 allows for maintenance of various databases without interfering with system operations for all aspects of the system 10. Additionally, using the separate servers 12,16,20, improves load balancing and stability by dividing the processing requirements across the system 10. However, the system 10 can be implemented without a separate application server 16. In such an embodiment, the automated registrar 18 could be installed on either the web server 12 or the database server 20, provided the automated registrar 18 is invoked by the submission of information from the web site.

The system 10 of the present invention allows a prospective transferee to enter his or her transcript information via the web page interface 14 into a web based form, submit the information to the web server 12, and receive an answer on-line and within seconds indicating the number of transferred credits that the system will grant provisionally. Transfer credits are granted provisionally pending confirmation of the transcript information of the transferee. Due to privacy concerns, transfer information cannot be verified digitally at this time. However, as digital signatures and third party certificate authorities become increasingly relied upon, it is anticipated that many educational institutions will provide digitally authenticated transcript information over the Internet to trusted third parties. Thus, verification of the transcript information may (in the near future) be performed programmatically.

Alternatively, by agreement, the system 10 may be permitted to request transcript information digitally from the transferee's previous college and receive a digitally transmitted copy of the transcript information over a secure channel (such as a direct dial-up channel or other secure point-to-point communication protocol).

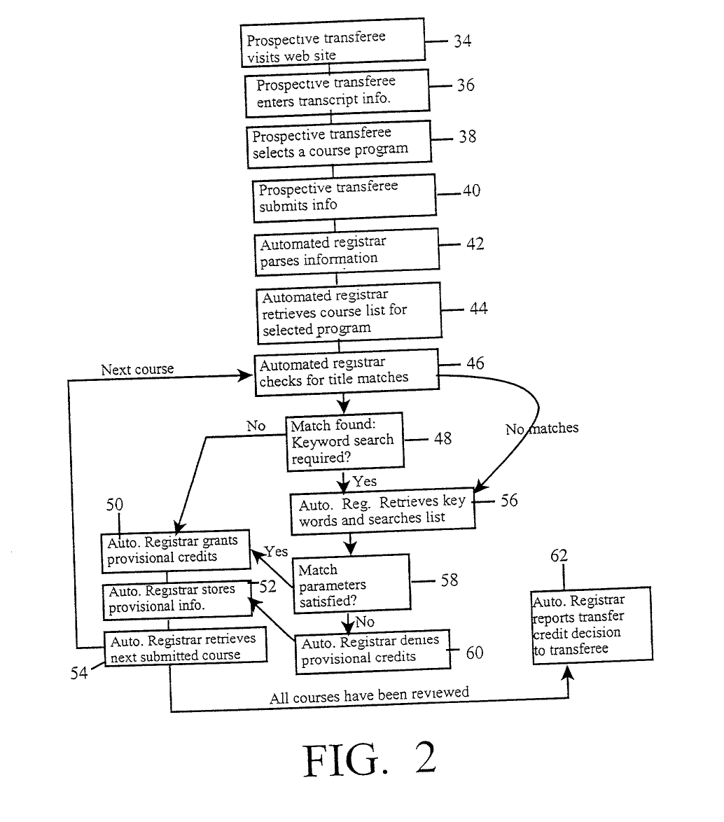

As shown in FIG. 2, a prospective transferee visits the website interface 14 (step 34) and enters his or her transcript information (step 36). The prospective transferee selects a course program (such as computer programming, electrical engineering, and the like) (step 38). Finally the prospective transferee submits the information to the system 10 (step 40). The submission may be triggered by a clickable button or icon in the web page form.

Once the prospective transferee submits the information, the automated registrar 18 parses the information (step 42). Then, the automated registrar 18 retrieves the course list for the selected course program (step 44). Next, the automated registrar compares each completed course from the submitted transcript information against the course list, looking for course title matches between the completed course and the selected course list (step 46).

If a course title match is found, the automated registrar 18 checks the course parameters to see if the a keyword search is also required (step 48). If no keyword match is required, the automated registrar 18 provisionally grants the transfer credits (step 50). The automated registrar 18 stores the granted transfer credits in a temporary data store (step 52), and then the automated registrar proceeds with the next course listed in the transferee's submitted transcript information (step 54).

As previously described, in some cases, the course title alone is not determinative of whether transfer credits should be granted. During setup and configuration of the course within the system 10, an administrator configures each course, including prerequisites, credits, and so on. In addition, the administrator can configure the class to require a percentage match of keywords in the event of an educational transfer. Specifically, the administrator configures the particular course to require a successful hit ratio of keywords (such as “>50%”) as compared with the corresponding course description from the transferee's previous college. Using keywords (such as “object-centered design or OCD”, C++, classes, templates, and inheritance), the automated registrar proceeds through a second-tier comparison of the course description against the keywords before rendering a transfer credit decision.

The keyword comparison involves searching the text of the retrieved course description for each keyword. Typically, the text is searched for the appearance of one keyword at a time. If the keyword is contained in the description, the result is a successful “hit.” It does not matter if the word appears once or 10 times, each keyword is responsible for one hit. Thus, the appearance of only one keyword six times in the description leads to a single hit. The correspondence comparison or hit ratio is calculated by dividing the number of hits by the total number of keywords in the set. Thus, in the example given above, five different keywords are provided (the “or” phrase causes the entire phrase to be equivalent). To achieve the required 50% or greater hit ratio, three of the five words must appear somewhere in the text of the retrieved course description.

If the keyword search is required, the automated registrar performs a keyword comparison (step 56). Similarly, if no match is found between the course titles, the automated registrar attempts to perform the keyword comparison (step 56). If the keyword match satisfies the percentage hit ratio parameter (step 58), the automated registrar 18 provisionally grants the transfer credits (step 50), the credits are stored in a temporary data store (step 52), and the automated registrar 18 proceeds with the next course in the submitted transcript information (step 54).

If the keyword match does not satisfy the percentage hit ratio parameter, the automated registrar 18 provisionally rejects the transfer credits (step 60). The rejection is stored in a temporary database record (step 52), and the automated registrar proceeds with the next course in the submitted transcript information (step 54).

Finally, once the automated registrar has evaluated each course in the submitted transcript, the automated registrar 18 reports the course list indicating the number of transfer credits provisionally granted and/or rejected (step 62) to the transferee via the web site interface 14.

If the course title does not match or if the keywords are required for a search, the automated registrar retrieves course catalog information from the prospective transferees previous college. Specifically, the automated registrar retrieves the course description for each course entered in the prospective transferees transcript information. Then, the automated registrar compares keywords from the course description from the prospective transferees selected course program against the course catalog description retrieved from the transferees previous college.

Depending on the level for which the prospective transferee is applying, a particular percentage of matches must be achieved before credit can be granted. In undergraduate program for an introductory course for instance, no keyword search may be required for an introductory course such as introduction to accounting. However, for graduate level courses and or upper level undergraduate courses some level of key word matching may be necessary to ensure that the student will not be left behind. Typically, a 50 percent keyword match is sufficient for lower level undergraduate courses. An 80 percent or greater match is required for graduate level and upper level undergraduate courses. If the key word match is successful according to the required percentage parameters, the automated registrar provisionally grants the credits and displays the results for the prospective transferee. If however the percentage match is below the required percentage parameter, the credit transfer is provisionally rejected. The system notifies the prospective transferee of the provisionally rejection and explains the circumstances under which the transfer of credits may be expected. Specifically, a registrar at the school will be notified electronically of the rejection so that the rejection can be reviewed. Thus, a staff member provides a check of transfer rejection decisions.

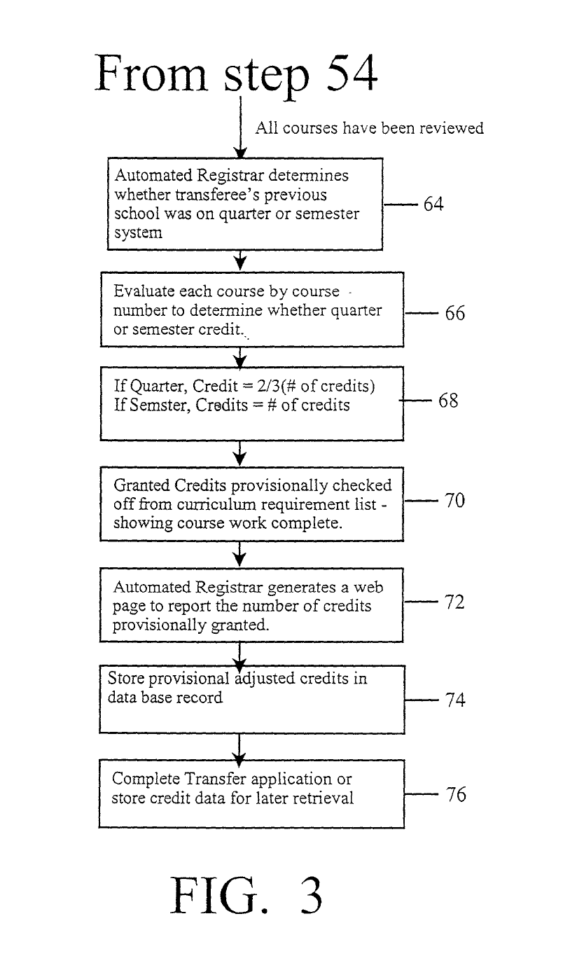

As shown in FIG. 3, the automated registrar 18 performs a number of steps in parallel to the credit decisioning process (shown in FIG. 2) to maintain a student's curriculum requirements. If either the title pass or the keyword search is successful, the transfer credits will be granted provisionally for that matched course (step 50). The process is repeated for each completed course listed on the submitted transcript.

Once all of the submitted transcript courses are reviewed (between steps, the automated registrar 18 determines whether (at the time the courses were completed) the transferee's previous school was on quarter or semester system (step 64). While a majority of Colleges and Universities organize their classes around a semester system, some organize around quarters. Typically, the quarter system classes have a shorter duration than semester system classes. Using the course number from the transferee's submitted transcript, the automated registrar 18 evaluates whether each course was completed under a quarter or semester system (step 66).

If the completed coursework involved quarter system classes, the automated registrar 18 adjusts the provisional credits (step 68). A quarter system class adjusts to approximately ⅔rds of a semester class for transfer credit purposes, such that six semester credits is equivalent to 4 quarter credits. Once the transfer credits have been calculated, the credits will be “checked off” provisionally from the prospective transferee's selected course program (step 70). Thus, the course work is indicated to be completed in the system 10. Then, the automated registrar 18 generates a web page to report the number of credits provisionally granted as well as the course requirements satisfied by the accepted credits (step 72). Thus, the system 10 shows the prospective transferee both the number of provisionally granted credits and the number of credits left to complete the selected degree program before the transferee is required to enter any demographic information.

Prospective transferees can use the system 10 to evaluate whether to transfer without wasting time on cumbersome applications details. For a busy professional who has limited free time available, taking a few minutes to enter completed course work allows the system 10 to provide a realistic snap-shot of the credits likely to be granted even before the person decides to apply. The system 10 stores the provisionally granted and adjusted credits in a database record (step 74).

Once the person has reviewed the provisional transfer credit decision, the transferee is invited either to complete a transfer application (step 74) or to save the transfer decision information (step 76). Thus, the system 10 temporarily stores the transfer credit information, and uses the information if the transferee decides to complete a transfer application. Otherwise, the system 10 purges provisionally granted credit information after a period of time, so as to minimize wasted space in the database. The period of time that provisionally granted credits are stored is established by an administrator at the host college or university.

The entire process of reviewing the transcript information and generating a result including the granting of provisional transfer credits can be performed within a matter of seconds. Routing delays, Internet and system traffic, the size of course descriptions, and the number of submitted completed courses are the sources of delay that contribute to the amount of time required to complete the transfer process.

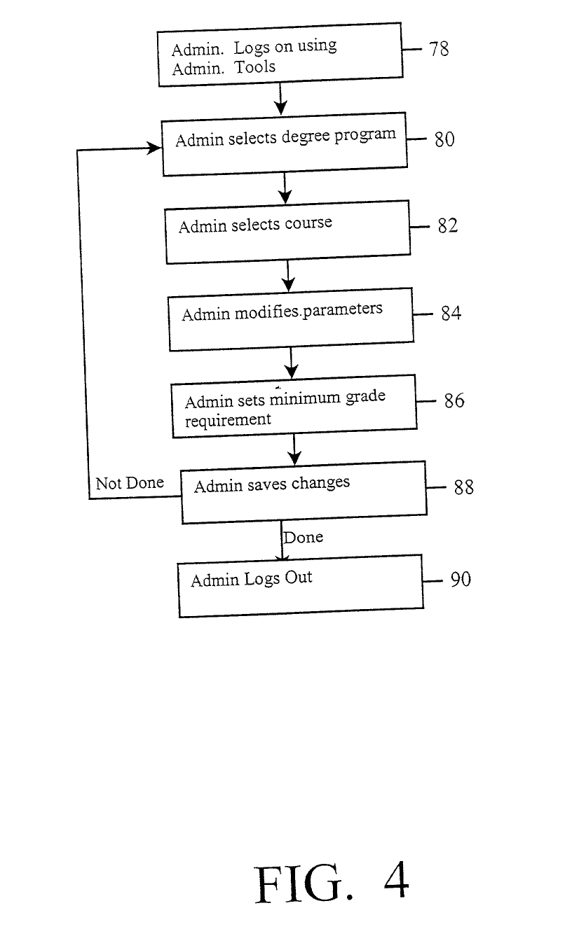

As shown in FIG. 4, an administrator at the college or university uses the administrative tools 24 to configure and modify parameters within the automated registrar 18. First, the administrator logs on to the server using the administrative tools 24 (step 78 ). Next the administrator selects a degree program to administer (step 80), then selects a particular course to administer (step 82). Then, the administrator modifies various parameters (step 84), such as the keyword list, course title, the percentage of hits required for allowing credits for that particular course, whether both a title search and a keyword search are required in all instances, and so on. Finally, the administrator sets a minimum grade required (step 86) to allow the credits to transfer from the prospective transferee's previous course work. Once the administrator has finished, the administrator can save changes (step 88).

The entry of a grade requirement is optional. If the Administrator or course instructor requires a grade, the web page requires the input. The automated registrar 18 will access the requirement if, based on the input, the course would be eligible for possible transfer. Thus, in a case where the prospective transferee received a “C” grade in a graduate level course, and the Administrator or course instructor requires a “B” or better, no credit will be provisionally granted. The course credit may ultimately be granted for the prospective transferee upon review by a registrar based on other factors, but the automated registrar will not provisionally grant the credits.

Additionally, the Administrator may make the entry of a grade from the web-site interface 14 optional. If the Administrator sets a parameter within the system 10 to require a grade input, the web page will require the input. Upon submission, the system will assess if the course work is eligible for transfer credits. If, however, the Administrator set the parameters not to require a grade input, all transfer assessment remains provisional and at the discretion of the school until receipt and verification by the Registrar. Such verification could be performed by a person, but preferably, the course work grades would be entered into the system 10 and evaluated programmatically.

Alternately, if the Administrator or course instructor does not require a grade input, all transfer assessment will be performed

If the administrator is done configuring the courses, the administrator can log out (step 90). Otherwise, the system 10 returns the administrator to the list of curriculum programs to edit (step 82).

Consolidation of the administrative and/or parameter modification resources in a single interface provides continuity between the various administrative functions for the University or college. The administrative tools 24 allow a registrar to create and modify reports, add and delete course, modify program requirements, review provisional rejections and so on. While setup and administrative tasks could be separated into different interfaces, in the preferred embodiment, one interface (administrative tools 24) is provided for all administrative tasks.

The administrative tools 24 can be installed on any computer in network communication with the application server 16 and the automated registrar 18. In the preferred embodiment, the administrative tools 24 are web-enabled, such that they operate within a web-browser (such as Netscape Navigator or Microsoft Internet Explorer, and the like) and are accessible directly through the web-interface 14. Thus, no local installation of administrative software is required. Furthermore, access to the administrative tools 24 is confined to authorized users.

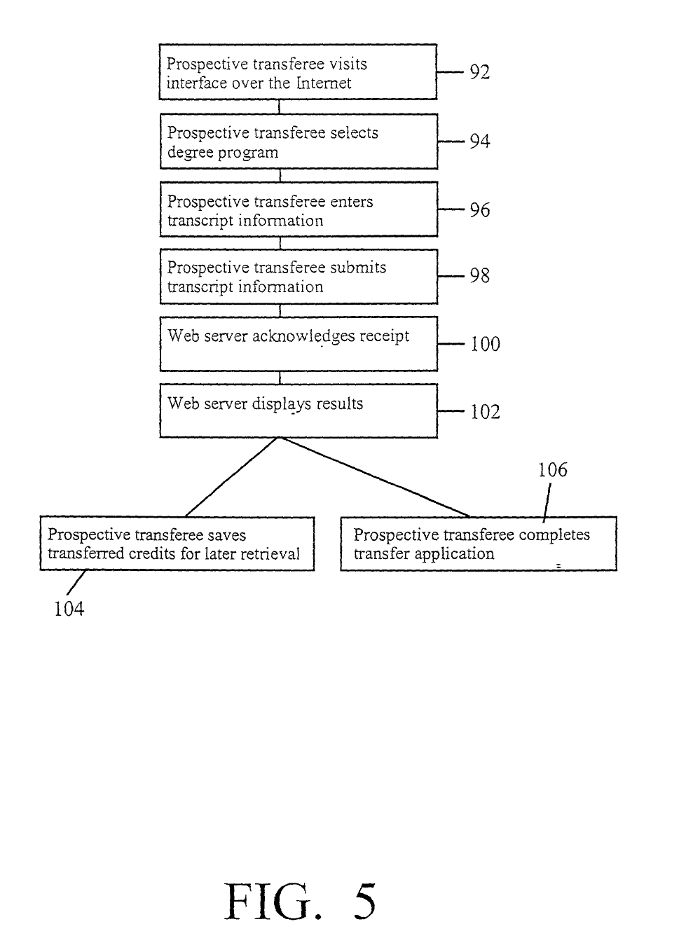

As shown in FIG. 5, a prospective transferee visits the Internet interface 14 over the Internet 26 (step 92) using a computer workstation, a digital phone, a PDA or other web-enabled device. The prospective transferee selects a degree program (step 94). Next, the prospective transferee enters his or her previous course work information into a web-based “transcript” form (step 96). The previous course work information typically includes the name of the previous school, the course number, the course title, the grade received, and the year the course was completed.

The prospective transferee submits the transcript information using a button on the Internet interface (step 98). The web server 12 causes the Internet interface 14 to acknowledge receipt of the information and to inform the prospective transferee that the automated registrar 18 is evaluating the information (step 100). Within seconds, the web server 12 displays the results of the evaluation and the course requirements satisfied by the transferred credits (step 102). Specifically, the web server 12 displays the list of the courses submitted with the total number of credits transferred. Additionally, the web server displays the transfer course adjacent the corresponding required course from the selected degree program, so that the prospective transferee can see how the transfer credits are being applied.

From this display page, the prospective transferee can save the transferred credits (step 104) for later retrieval, or the prospective transferee can complete the transfer application by entering demographic information (step 106). If the transfer credits are saved, the prospective transferee may return to the system 10 later to retrieve the saved transfer credits and complete the application (step 106).

The entire process for evaluating the credits can be performed using the automated registrar 18. The automated registrar 18 reviews the course title and course description from the transferee's previous college and compares them against the title and/or key words from the required courses within the selected degree program to determine whether or not transfer credits should be granted. Additionally, the automated registrar 18 automatically compares the transferees grade from the previous course against a required grade for allowance of transfer credits. The entire process is performed within a matter of seconds, and a result is returned to the applicant via the Internet.

All credit decisions are granted provisionally pending verification of the transcript information. As digital signatures and certificate authorities become more common place, it will become possible to retrieve transcript information digitally in the near future. In that case, the step of provisionally granting credits pending confirmation maybe eliminated. Thus, the application for transfer and the examination of the transferees transcripts is performed automatically and digitally within seconds of the applicant's submission. The automated registrar 18 then grants the credits based on the evaluation parameters set by the administrative tools 24.

A heuristic electronic match of the titles of introductory-level courses is sufficient in most cases to justify the granting of credits corresponding to required introductory courses in the selected degree program, provided the student performed sufficiently well in their previous course experience. Generally, a grade of C or lower may be insufficient to grant transfer credits to the prospective transferee, because such a grade reflects only a satisfactory understanding of the material. Furthermore, in some instances, the grade alone does not reflect whether the student learned sufficient information in their previous course work.

Using the Administrative tools 24, the automated registrar 18 may be configured to consider the quality of the transferee's previous school. The system 10 may be configured to weight the grades according to the quality of the previous school. Using a pre-configured ranking system based on the quality of the various schools, the automated registrar 18 assigns a score to various programs. This score may be generated automatically by downloading and/or entering a list of the top 100 schools from U.S. News And World Report or from various other sources. Thus, a student who transfers credits from Yale University or Stanford University, schools typically ranked in the top five in the country for undergraduate institutions, may be allowed transfer credits for course work even if the student received a grade below the cutoff. Since grading at most institutions reflects a comparative evaluation of the student's performance relative to other students in a class, a C grade reflects both the student's performance and the quality of the students in the class. Thus, other factors, such as the quality of the institution may be considered by the system 10.

The system 10 of the present invention can maintain a self-populating database of course catalog descriptions. As each new transfer student signs onto the system 10, the system 10 retrieves the course catalog description from the transferee's college and adds the information to its database 22. Future transferee's from the same college will have their transcript information evaluated against the stored course description, instead of retrieving the course description each time. The course description can be stored according to year so that a student who took Introduction to Accounting at University A in 1993 might be compared to a different course description from a student who took the same course at the same school in 1995, depending on whether the course descriptions changed. Thus, the course catalog description database is self-populating.

The automated registrar 18 retrieves the course catalog information by searching for the course catalog information automatically over the Internet 26. Alternatively, the prospective transferee may be prompted to direct the automated registrar 18 to the course catalog from the transferee's previous college.

The automated registrar 18 can be configured to adjust the number of credits depending on whether they were quarter or semester credits. As previously mentioned, credits taken under a quarter system are converted by a ratio of 1.5 quarter credits to 1 semester credit. Thus 6 quarter credits translates to 4 semester credits, and so on.

As previously indicated, for certain classes the title of the class alone may be sufficient to determine whether credits should be transferred. In the sciences, a more exacting keyword search maybe required to ensure that the student is familiar with the background material so that the transfer student does not get left behind.

It is anticipated that as the system grows it maybe desirable to place different degree programs on different servers. Thus, the choice by the transferee of the particular program of study would determine which server on the back end would be accessed by the automated registrar 18. Additionally, for the purpose of determining whether credit should be transferred, required classes within a particular speciality may require more exacting matches between keywords and the transferee college course description than in elective course, such that while some courses in the degree program may require only a 50% or greater match, one or two courses may require a 90% or greater match. Each programs specific prerequisite parameters may be customized accordingly.

Once the evaluation process is complete the prospective transferee can receive an instant decision of acceptance pending receipt of the official transcript. Additionally, the prospective transferee may be invited to call the registrar office or be told that a registrar will be contacting the prospective student directly in the event that certain credits did not transfer. Admission requirements may also be set by the registrar to require a GPA of a certain level or higher, of particular combination of exams scores, standardized test scores, GPA and the like. Each of these parameters may be added to the credit transfer form, and evaluated before the credits are evaluated.

All students within the system 10 are in one of three statuses: Pending, Provisional Pending, or Full Admission. A pending student is one who has transferred but has not been accepted to a particular program, or whose credits have not transferred. A pending provisional student is a student who has applied for transfer and credits have been granted or not granted pending receipt of the official transcript. A fully admitted student is one who has completed the transfer process and for whom the transcript information has been verified using an official transcript.

The system 10 removes the guess work from whether or not to grant transfer credits for particular students. By allowing the student to enter their transcript and grade information on a secure server on the Internet 18, the system 10 then processes digitally the transcript information to provide an instant provisional credit transfer decision. The system 10 allows prospective transferees to shop around for the best transfer options toward a completed degree program.

As described, the system 10 is implemented for a single educational institution, such that the transfer credits are evaluated for transfer into one school. However, the system 10 could provide the same systematic evaluation for more than one school, and display a list of the transfer options to the student for his or her review. In this configuration, the system 10 allows schools to compete for business, and it provides a one-stop shop for prospective students to find the best transfer option for their education dollars.

The system 10 permits a prospective transferee to enter his or her transcript information without the corresponding demographic information. By doing so, the system 10 allows a student to maximize his or her time. A prospective transferee can determine whether completing the transfer application is worthwhile before taking time out of a busy schedule. The prospective transferee can evaluate the number of credits that will be granted and make his or her own decision whether to follow through with the application process, thereby avoiding the entire registration process until they are ready to proceed. This arrangement reduces the number of wasted database records by only storing transcript information temporarily, pending a completed application or a timed deletion. Additionally, by separating the automated registrar 18 evaluation process from the transfer application, the system 10 reduces overall processing by removing the acceptance decision from the credit decision process. Thus, fewer steps are involved at this stage. Finally, users need not complete lengthy applications, until a provisional credit decision is reported so that the prospective transferee can evaluate whether a transfer is worthwhile.

The demographic and transcript information, once submitted to the web server 12, is recorded directly in the database 22. Thus, manual entry of the transcript and student information is minimized. Verification of the process requires only a check of the accuracy of the submitted data.

While the system 10 has been described with respect to submission of transcript information independent of the transfer application, the system 10 may be used in conjunction with the submitted transfer application so that the transfer application and transfer credit decisions are made concurrently or in succession.

Finally, an alternative embodiment of the present invention allows the prospective transferee to submit an official transcript via traditional mail service. An employee of the school can enter the transcript information through the web site interface 14. Thus, the system 10 allows traditional mail-in transfer students to be evaluated using the same standards and parameters as on-line students.

Although the present invention has been described with reference to preferred embodiments, workers skilled in the art will recognize that changes may be made in form and detail without departing from the spirit and scope of the invention.

1. A system for programmatically determining educational credits for a transfer student, the system comprising:
a database containing course requirement records relating to degree programs;
a secure web site interface in network communication with the database, the secure web site interface providing a form for selection of an degree program and for entry and submission of transcript information; and
an automated registrar in network communication with the database and the secure web site interface, the automated registrar providing a programmatic evaluation of submitted transcript information as compared with the course requirement records;
wherein the automated registrar generates a provisional transfer report for a user based on the submitted transcript information and a selected degree program.

2. The system of claim 1, further comprising:
an alert mechanism for programmatically notifying a registrar when the submitted transcript information does not qualify for transfer credits.

3. The system of claim 1, further comprising:
a report interface for displaying a provisional acceptance of transfer credits based on the programmatic evaluation of the submitted transfer information.

4. The system of claim 1, further comprising:
a course catalog database comprised of records containing course descriptions from a plurality of institutions of higher learning.

5. The system of claim 1, wherein the automated registrar is a software component capable of programmatically retrieving course descriptions from institutions of higher learning, evaluating the retrieved course descriptions according to course parameters, and rendering a provisional transfer credit decision automatically.

6. The system of claim 1, wherein the provisional transfer report is conditioned upon verification of the submitted transcript information.

7. A method for automatically rendering a credit transfer decision for course work completed at another educational institution, the method comprising:
receiving a degree program selection and a digital record of transfer information relating to courses completed by a prospective transferee, the transfer information including an educational institution identifier, a course title, a course number, and a grade associated with each course;
retrieving program requirements from a database, the program requirements corresponding to the degree program selection;
evaluating a correspondence between the course title and course titles of required courses within the retrieved program requirements; and
rendering a conditional credit transfer decision based on the evaluation.

8. The method of claim 7, wherein rendering a conditional credit transfer decision, further comprises:
retrieving programmatically a course description from the educational institution according to the educational institution identifier associated with each course;
retrieving keywords associated with each course in the retrieved program requirements;
evaluating a correspondence between the retrieved course description and the retrieved keywords for each course in the retrieved program requirements; and
rendering the conditional credit transfer decision based on the evaluated correspondence.

9. The method of claim 7, the method further comprising:
determining whether a keyword match is required according to parameters associated with the required course; and
retrieving programmatically a course description from the educational institution according to the educational institution identifier associated with the course;
retrieving keywords associated with the course in the retrieved program requirements;
evaluating a correspondence between the retrieved course description and the retrieved keywords for the course in the retrieved program requirements; and
rendering the conditional credit transfer decision based on the evaluated correspondence.

10. The method of claim 7, the method further comprising:
displaying an electronic transfer application for the prospective transferee after the conditional transfer decision has been rendered.

11. The method of claim 7, wherein before the step of receiving, the method further comprises:
configuring degree programs in the database;
configuring courses within the database, each course having at least a course title, a number of credits, and a keyword parameter for determining whether a keyword evaluation is required;
associating each course with at least one degree program in the database; and
associating key words with each course.

12. The method of claim 7, wherein evaluating a correspondence comprises:
matching the course title word-for-word against the course titles for required courses.

13. The method of claim 8, wherein evaluating a correspondence comprises:
matching a set of key words associated with a particular course in the retrieved program requirements against the retrieved course description to calculate a number of hits, the number of hits corresponding to a hit for each keyword appearing in the retrieved course description;
deriving a correspondence percentage by dividing the number of hits by a total number of keywords in the set of keywords; and
rendering the provisional transfer credit decision based on the correspondence percentage.

14. The method of claim 13, wherein the correspondence percentage is greater than 50%.

15. A method for programmatically rendering an educational credit transfer decision for completed course work, the method comprising:
receiving a selected degree program and a completed course title, an associated school identifier, and an associated course number;
retrieving a course list from a database based on the selected degree program, the course list including titles and associated keywords;
retrieving a course description corresponding to the course number from a remote school corresponding to the associated school identifier;
comparing each keyword with the retrieved course description to determine a successful hit ratio, the successful hit ratio corresponding to a number of keywords appearing in the retrieved course description divided by the total number of keywords; and
awarding provisionally transfer credits according to the successful hit ratio.

16. The method of claim 15, wherein the receiving step further comprises:
receiving a grade associated with the completed course work.

17. The method of claim 16, wherein before awarding transfer credits, the method further comprises:
retrieving a minimum transfer grade score from the database, the minimum transfer grade score associated with a highest correlation course in the selected degree program, the highest correlation course being a course within the selected degree program having a highest hit ratio as compared with other courses in the selected degree program; and
determining whether the grade associated with the completed course work is greater than or equal to the minimum transfer grade score.

18. The method of claim 15, wherein the successful hit ratio must be greater than 80%.

19. The method of claim 15, wherein the successful hit ratio must be greater than 50%.

20. A method of evaluating transfer credits, the method comprising:
matching a completed course title against a required course title; and
granting programmatically provisional education transfer credits based on a percentage ratio correspondence between the completed course title and the required course title.

21. A method for automatically rendering a provisional credit transfer decision for course work completed at another educational institution, the method comprising:
configuring an automated registrar to receive and evaluate transfer information;
configuring a database to require transcript information from a transferee, the transcript information including a course title and a course number;
receiving a degree program selection and a digital record of transfer information from a prospective transferee relating to courses completed by the prospective transferee, the transfer information including an educational institution identifier, a course title, and a course number, associated with each course;
retrieving programmatically program requirements from a database, the program requirements corresponding to the degree program selection;
evaluating a correspondence between the course title and course titles of required courses within the retrieved program requirements; and
rendering the provisional credit transfer decision for the prospective transferee based on the evaluation.

22. The method of claim 21, wherein the course title and the course titles of required courses do not correspond, the method further comprising:
retrieving programmatically course descriptions corresponding to the course number from a remote educational institution based on the received educational institution identifier; and
evaluating a correspondence between the retrieved course description and a course description of required courses within the retrieved program requirements; and
rendering the provisional credit transfer decision based on the evaluation.

23. A method according to claim 21, further comprising:
configuring the automated registrar to require a grade corresponding to the transcript information.

24. A method according to claim 23, wherein before rendering the provisional credit transfer decision, the method further comprises:
evaluating a received grade corresponding to the transcript information against a required grade.
